(19) United States
(12) Patent Application Publication
(10) Pub. No.: US 2017/0028412 A1
(43) Pub. Date: Feb. 2, 2017

(54) SHOWER HEAD ASSEMBLY

(71) Applicant: Multishower GB Ltd, County Londonderry (GB)

(72) Inventors: Christie ALLEN, County Londonderry (GB); James CLARKE, County Londonderry (GB)

(21) Appl. No.: 15/303,165

(22) PCT Filed: Apr. 9, 2015
(86) PCT No.: PCT/EP2015/057695

§ 371 Date: Oct. 10, 2016

(30) Foreign Application Priority Data
Apr. 10, 2014 (GB) 1406475.2

(51) Int. Cl. B05B 1/18; E03C 1/04

(52) U.S. Cl. CPC B05B 1/185; E03C 1/0408

(57) ABSTRACT

A shower head assembly (2) comprising a body (4) having a flow passage (10) therethrough, said flow passage (10) having an outlet opening (16) at an outer end thereof, and a plurality of inserts (18), each insert (18) being adapted to be releasably mounted within the outlet opening of the body and including a flow restriction adapted to create a spray of water from the shower head, each insert being securable within the outlet opening by cooperating formations (20) formed on an outer wall of the insert (18) and an inner wall of said outlet opening (16) enabling periodic removal and replacement of the insert (18) from the outlet opening (16) of the body (4). Preferably said inserts (18) are visually distinguishable from one another.

### FIELD OF THE INVENTION

The present invention relates to a shower head assembly and in particular to a shower head assembly for use in hospitals and other healthcare facilities to prevent the spread of legionella bacteria.

### BACKGROUND OF THE INVENTION

A shower head typically comprises a body having a flow passage for the passage of water communicating with an opening to which is attached an apertured spray plate or rose for providing a dispersed spray of water therefrom. There is a concern that shower heads may be a breeding ground for bacteria that are known to cause respiratory infections, and in particular legionella bacteria causing legionellosis.

Legionellosis is the collective name given to the pneumonia-like illness caused by legionella bacteria. This includes the most serious legionnaires' disease, as well as the similar but less serious conditions of Pontiac fever and Lochgoilhead fever. Legionnaires' disease is a potentially fatal form of pneumonia and everyone is susceptible to infection.

The bacterium Legionella pneumophila and related bacteria are common in natural water sources such as rivers, lakes and reservoirs, but usually in low numbers. They may also be found in purpose-built water systems such as cooling towers, evaporative condensers and whirlpool spas.

If conditions are favourable, the bacteria may grow increasing the risks of legionnaires' disease.

People can catch legionnaires' disease by inhaling small droplets of water, suspended in the air, containing the bacteria. Certain conditions increase the risk from legionella, including:
water temperature between 20° C. and 45° C., which is suitable for growth;
creating and spreading breathable droplets of water, e.g. aerosol created by a cooling tower, or water outlets;
stored and/or re-circulated water;
a source of nutrients for the organism e.g. presence of sludge, scale or fouling.

Shower heads can become a breeding ground for such bacteria. Showers deliver water at approximately 45° C., which is an ideal temperature for pathogens to proliferate. Showers are only used intermittently, allowing long periods of stagnation which aids bacteria to multiply. The spray plates of shower heads act as filters trapping debris and scale which can be used by bacteria both as a nutrient and a safe habitat. Finally, the purpose of a shower head is to spray water, creating aerosols which facilitate the transfer of the bacteria into the lungs.

A proposed solution to this problem for water distribution in hospitals and other healthcare facilities is to filter the water at the point of use. Taps and showerheads can be fitted with a filter that transmits water molecules but prevents the passage of the relatively large Legionella bacteria. However, this solution can be costly and requires a high degree of maintenance, as filters of this type have a very limited lifetime and need regular replacement. For example, Aquasafe produce a disposable shower containing a filter located in the handle for removing Legionella bacteria. Laboratories Anios also manufacture disposable filtration devices which can be fitted directly to a shower hose. However, these devices have a relatively low effective surface area, particularly as a result of the relatively limited space typically available in such devices. As a result, the filters of these devices quickly become saturated, resulting in the lifetimes of the devices being short relative to the lifetime of a standard shower unit. Therefore existing filtration devices require frequent replacement, which can involve considerable effort and expense. Presently the only alternative to filters is to regularly replace or sterilise the shower head, which is also costly and prone to error (e.g. staff may forget to change or clean the shower head when required).

It is an object of the present invention to at least mitigate some of the problems of the prior art

### SUMMARY OF THE INVENTION

According to the present invention there is provided a shower head assembly comprising a body having a flow passage therethrough, said flow passage having an outlet opening at an outer end thereof, and a plurality of inserts, each insert being adapted to be releasably mounted within the outlet opening of the body and including a flow restriction adapted to create a spray of water from the shower head, each insert being securable within the outlet opening by cooperating formations formed on an outer wall of the insert and an inner wall of said outlet opening enabling periodic removal and replacement of the insert from the outlet opening of the body.

Preferably said inserts are visually distinguishable from one another. In one embodiment each of said plurality of inserts may be a different colour.

Preferably said cooperating formations enable removal of a respective insert from the outlet opening by rotation of the insert with respect to the body. In one embodiment said cooperating formations may comprise cooperating threads formed on the outer wall of each insert and the inner wall of the outlet opening of the body. Alternatively said cooperating formations may comprise a bayonet fitting comprising pins provided one of the outer wall of each insert and the inner wall of the outlet opening of the body and cooperating L shaped slots provided on the other of the outer wall of each insert and the inner wall of the outlet opening for receiving said pins to retain each insert respectively within the outlet opening.

The assembly may further comprise a tool having recesses adapted to engage projections formed on an outer face of each insert whereby said recesses on the tool can be engaged with said projections on a respective insert to facilitate rotation of the insert with respect to the tool. A first tool may be provided having recesses adapted to engage said projections on a respective insert to enable rotation of the insert in a first direction to enable removal of the insert from the outlet opening and a second tool having recesses adapted to engage said projections on a respective insert to enable rotation of the insert in a second direction, opposite said first direction, to enable the insert to be secured within the outlet opening.

In one embodiment an outer face of each insert may include a plurality of apertures formed therein defining a spray plate.

In an alternative embodiment each insert may include a deflector element integrally formed therein, said deflector element comprising a head portion arranged to be located centrally within the insert and an elongate stem extending inwardly from the head portion into said flow passage of the body when the insert is located within the outlet opening of the body to define a flow restriction within said flow passage, the deflector element being supported within the insert by at least one elongate rib extending between the outer wall of the insert and the deflector element. The deflector element of each insert may be supported by a plurality of radially extending ribs extending between the outer wall of the insert and the deflector element, said ribs being equi-spaced around the deflector element. The ribs may define said projections engaged by said recesses on said tool or tools.

An underside of the head portion of the deflector element of each insert may define a dish shaped surface facing the flow passage of the body when the respective insert is located within the outlet opening of the body of the shower head. The walls of the flow passage of the body may comprise an enlarged region having a conical surface converging axially outwardly and terminating in a substantially cylindrical surface to define a bowl shaped region, wherein said head portion of the deflector element is located immediately upstream of said bowl shaped region when the respective insert is located within the outlet opening of the body. At least a portion of the stem of the deflector element and/or a cooperating region of the flow passage may be tapered or otherwise shaped such that the flow restriction defined by said tapered region within the flow passage can be adjusted by adjusting the axial position of the respective insert within the outlet opening of the body.

### BRIEF DESCRIPTION OF THE DRAWINGS

Preferred embodiments of the present invention will now be described, by way of example only, with reference to the accompanying drawings, in which:

FIG. 1 is a face view of a shower head assembly in accordance with a first embodiment of the present invention;

FIG. 2 is a side view of the shower head assembly of FIG. 1;

FIG. 3 is a rear view of the shower head assembly of FIG. 1;

FIG. 4 is a longitudinal sectional view of the shower head assembly of FIG. 1;

FIG. 5 is a detailed perspective view of the insert of the shower head assembly of FIG. 1;

FIG. 6 is a face view of an insert of a shower head assembly in accordance with a second embodiment of the present invention;

FIG. 7 is a face view of the shower head assembly of the second embodiment of the invention with the insert attached;

FIG. 8 is a side view of an insert of a shower head assembly in accordance with a third embodiment of the present invention;

FIG. 9 is a longitudinal sectional view of the insert of FIG. 8;

FIG. 10 is a detailed sectional view of a shower head assembly incorporating the insert of FIG. 8;

FIG. 11 is a side view of a tool for removing or inserting the insert of any of the shower head assemblies of FIGS. 1 to 10;

FIG. 12 is an end view of the tool of FIG. 11;

FIG. 13 is further side view of the tool of FIG. 11;

FIG. 14 is an end view of a modified tool adapted to only remove the insert of any of the shower head assemblies of FIGS. 1 to 10; and

FIG. 15 is an end view of a modified tool adapted to only insert the insert of any of the shower head assemblies of FIGS. 1 to 10.

### DETAILED DESCRIPTION OF THE DRAWINGS

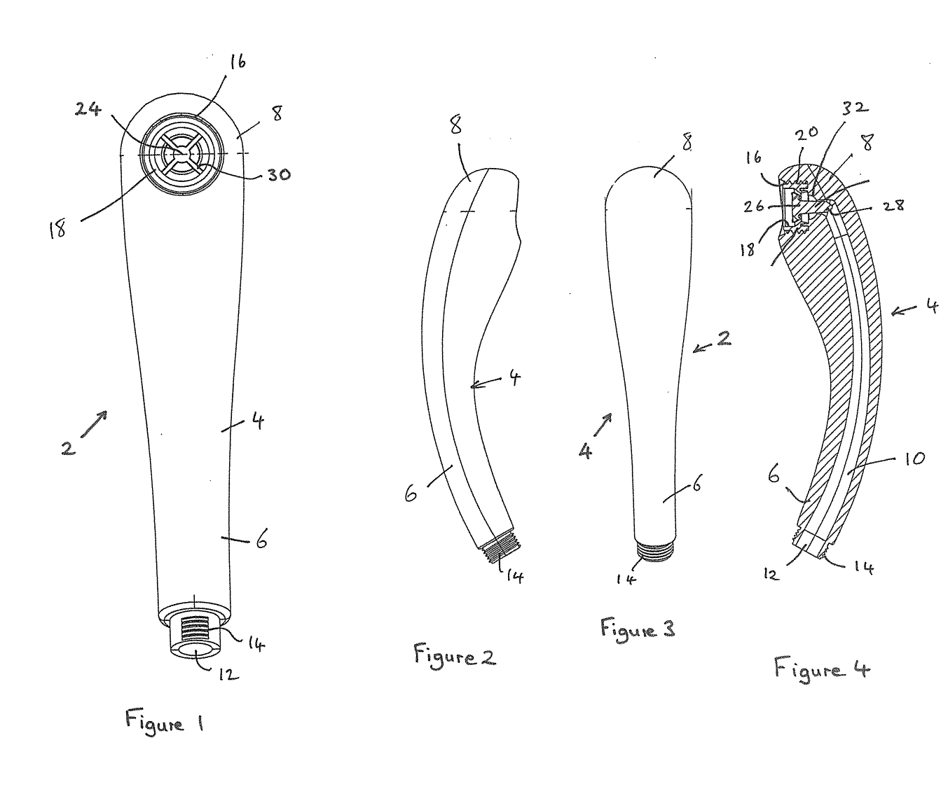

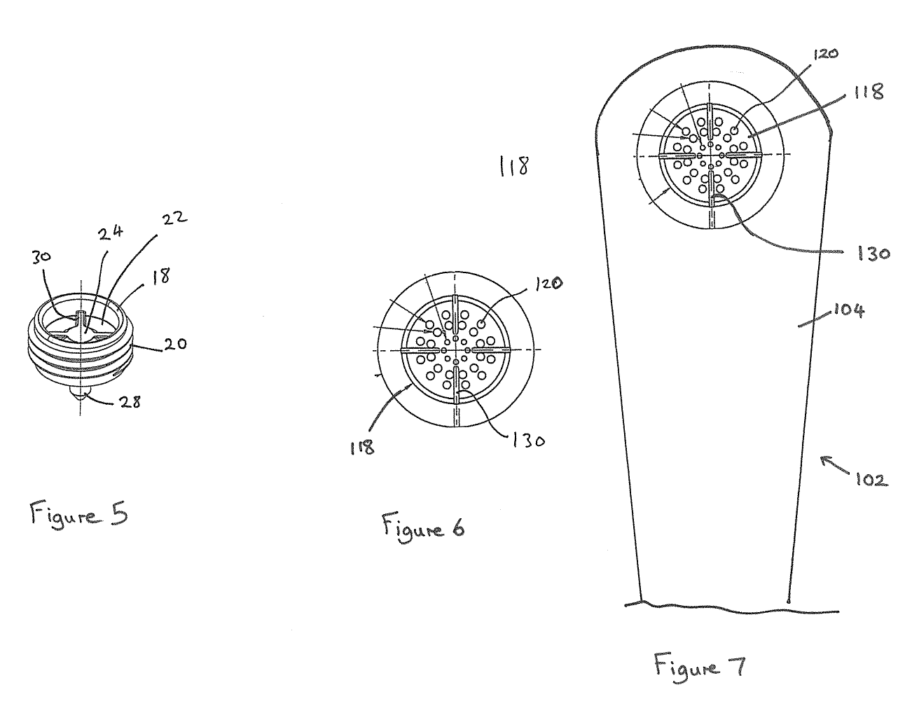

A shower head assembly in accordance with a first embodiment of the present is illustrated in FIGS. 1 to 5. The shower head assembly 2 comprises a moulded plastic body 4 defining a handle portion 6 and a head portion 8. A flow passage 10 extends through the body 4 from an inlet end 12 at a distal end of the handle portion 6 to an enlarged discharge opening 16 in the head portion 8 of the body 4. A threaded hose connection 14 is provided at said distal end of the handle portion for connecting a flexible water supply hose to the flow passage 10,

The discharge opening 16 of the flow passage 10 is adapted to receive an insert 18 adapted to generate a fine spray of water from the discharge opening 16 of the flow passage 10 when water is supplied to the shower head assembly 2.

In the embodiment shown in FIGS. 1 to 5, the insert 18 and the discharge opening 16 of the flow passage 10 within which the insert 18 is received are provided with cooperating threaded portions 20, enabling the insert 18 to be screwed into and out of the body 4 of the shower head assembly 2, facilitating periodic replacement of the insert 18, as will be described below in more detail.

In the embodiment shown in FIGS. 1 to 5, the insert 18 comprises an annular wall portion 22 defining an annular through channel (the respective threaded portion of the insert 18 being defined by an outer surface of the annular portion 22).

A deflector element 24 is integrally formed with the insert 18, said deflector element 24 comprising a head 26 centrally located within said annular through channel and an inwardly extending stem 28 arranged to extend into a narrowed portion of the flow passage 10 upstream of the discharge opening 16 when the insert 18 is inserted into the discharge opening 16 of the body 4 of the spray head assembly 2, as best shown in FIG. 4, such that a flow restriction is defined between the inner wall of the flow passage 10 and an outer wall of the stem 28.

The deflector element 24 is mounted within the through channel of the insert 18 by 30 four equi-spaced ribs 30 (shown in FIG. 1) extending between the annular wall portion 22 of the insert 18 and the head 26 of the deflector element 24. This ensures that the deflector element 24 is centrally located within the discharge opening 16 of the flow passage 10. As well as supporting the deflector element 24, the ribs 30 are able to interact with a tool to facilitate insertion and removal of the insert, as will be described below in more detail.

The insert 18 and deflector element 24 are preferably integrally formed as a single component.

The deflector element 24 comprises a rotationally symmetrical body. The underside of the head 26 of the deflector element 24 defines a dish shaped surface facing an outlet region of the flow passage 10 upstream of the outlet opening 16.

The walls of the outlet region of the flow passage comprise a conical surface converging axially outwardly and terminating in a substantially cylindrical surface to define a bowl shaped region 32 directly upstream of the head 26 of the deflector element 24.

The axial distance between the head 26 of the deflector element 24 and the bowl shaped region 32 of the flow passage 10 may be adjusted by rotating the insert 18 with respect to the body 4 to adjust the spray characteristics of water leaving the spray head via the flow path between the deflector element 24 and the surrounding annular wall portion 22 of the insert 18. Alternatively the distance may be set to provide the desired spray characteristics when the insert 18 is fully screwed into the body 4 of the spray head assembly 2.

The insert 18 of the shower head assembly of FIGS. 1 to 5 provides benefits of low water consumption and desirable spray characteristics compared to known apertured spray plates of more traditional shower heads, while being less prone to blockage or the trapping of debris or scale within the shower head assembly than prior art designs.

In an alternative embodiment, shown in FIGS. 6 and 7, the insert 118 may comprise a simpler design, having a plurality of small apertures 120 formed in an outer face of the insert 118, such that the outer face of the insert 118 defines a spray plate, water from the flow passage of the body 104 of the shower head assembly 102 being constrained to pass through said apertures 120 to break the flow of water from the flow passage 10 into a spray as it exits the inert 18 of the shower head assembly.

As with the insert 18 of the first embodiment of the present invention, although no longer required to support a deflector element, an outer face of the insert 118 is provided with four equi-spaced ribs 130. The purpose of such ribs 130 is to interact with a tool to facilitate insertion and removal of the insert, as will be describe below in more detail.

As with the first embodiment, the insert 118 and the discharge opening 116 of the flow passage within which the insert 118 is received may be provided with cooperating threaded portions (not shown), enabling the insert 118 to be screwed into and out of the body 104 of the shower head assembly 102, facilitating periodic replacement of the insert 118, as will be described below in more detail.

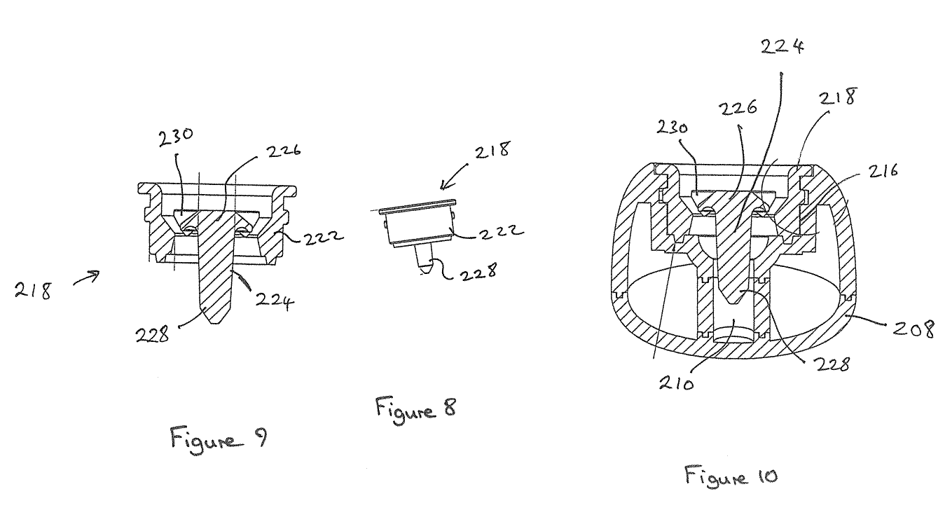

A shower head assembly in accordance with a third embodiment of the present invention is illustrated in FIGS. 8 to 10. The insert 218 is similar to that of the first embodiment, comprising a deflector element 224 integrally formed with the insert 218, the deflector element 224 comprising a head 226 centrally located within an annular through channel defined within an annular wall portion 222 of the insert 218 and an inwardly extending stem 228 arranged to extend into a narrowed portion of the flow passage 210 upstream of the discharge opening 216 when the insert 218 is inserted into the discharge opening 216 of the head portion 208 of the spray head assembly, as best shown in FIG. 10, such that a flow restriction is defined between the inner wall of the flow passage 210 and an outer wall of the stem 228.

The deflector element 224 is mounted within the through channel of the insert 218 by four equi-spaced ribs 230 extending between the annular wall portion 222 of the insert 218 and the head 226 of the deflector element 224. This ensures that the deflector element 224 is centrally located within the discharge opening 216 of the flow passage 10. Again, as well as supporting the deflector element 224, the ribs 230 are able to interact with a tool to facilitate insertion and removal of the insert, as will be described below in more detail.

The main difference between the embodiment shown in FIGS. 8 to 10 and that of FIGS. 1 to 5 is in relation to the mounting of the insert 218 within the discharge opening 216 of the flow passage 210. Instead of a threaded connection, the insert 218 and discharge opening 216 are provided with a bayonet type fitting, wherein a pair of opposed lugs 220 are provided on the outer surface of the insert 18, said lugs 220 being received within substantially L shaped slots formed in an inner wall of the discharge opening 216 formed in the head portion 208 of the body of the shower head assembly. Such bayonet type fitting enables the insert 218 to be fitted into the discharge opening 216 of the body of the shower head assembly by pushing the insert 218 axially into the discharge opening 216, with the lugs 220 aligned with first portions of the L shaped slots, and subsequently rotating the insert 218 with respect of the head portion 208 of the body of the shower head assembly such that the lugs 220 slide along second portions of the L shaped slots to secure the insert 218 within the discharge opening 216. The insert 218 may be removed by first rotating the insert 218 with respect to the head portion 208 of the body of the shower head assembly and then axially withdrawing the insert 218 from the discharge opening 216.

It is also envisaged that the bayonet fitting of the embodiment shown in FIGS. 8 to 10 may also be utilised to secure an insert of the type disclosed in FIGS. 6 and 7 within the discharge opening of the head portion of the shower head assembly, instead of a threaded fitting.

The insert 18,218,318 of the shower head assembly in accordance with any of the above described embodiments may be formed from a plastic material and may be formed by an injection moulding process. The plastic material forming the insert and/or the body of the shower head assembly may incorporate a material having anti-microbial properties, such as those marketed by Biomaster (RTM) Antimicrobial Technology.

As described above in relation to the prior art, the spray plate of known shower heads act as filters trapping debris and scale which can be used by bacteria both as a nutrient and a safe habitat. Even the provision of a deflector element as described herein results in the formation of flow restrictions in the shower head assembly that can trap debris and scale and retain water within the shower head assembly. The ability to easily and quickly replace the insert of the shower head assembly obviates this problem without requiring replacement of the entire shower head assembly.

The shower head assembly in accordance with any of the above described embodiments of the present invention is preferably provided with a plurality of interchangeable inserts 18,218,318, each insert being coloured differently from the others, or being otherwise visually distinguishable from one another. In use, each colour of insert can be provided for use during a predetermined period of time, for example a specific three months period, before being required to be replaced by an insert of a different colour. Thus a very quick visual inspection can verify whether or not replacement of the insert has taken place when scheduled.

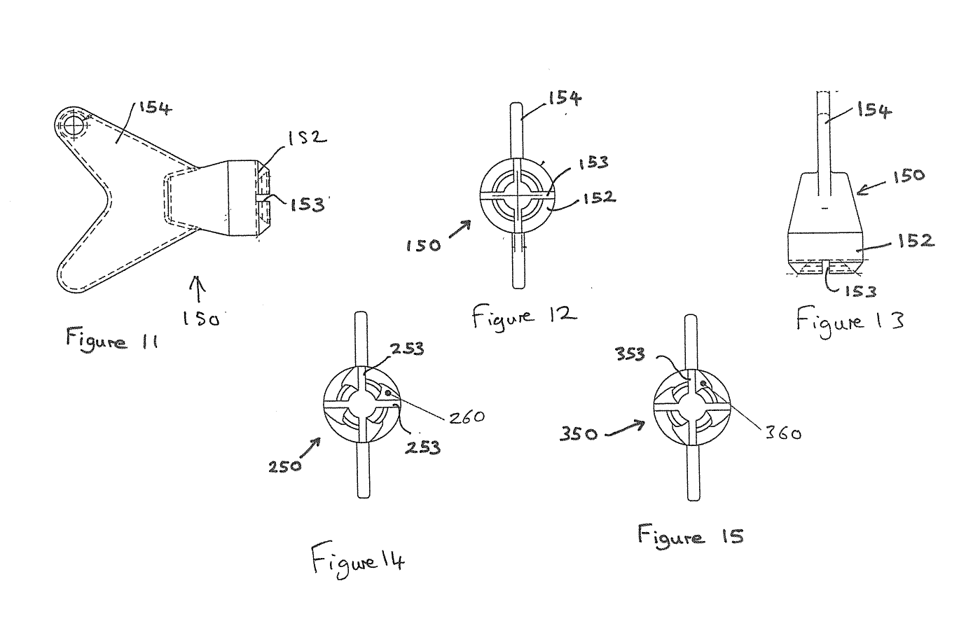

As shown in FIGS. 11 to 13, a tool 150 may be provided for removing and inserting the insert 18,118,218 of any of the shower head assemblies described above, said tool 150 having a slotted head 152 having grooves or slots 153 adapted to engage the radially extending ribs 30,130,230 of the insert, so that the insert can be readily rotated with respect to the discharge opening of the head portion of the body of the shower assembly by manipulation of wings 154 portions extending from the head 152 of the tool 150.

To avoid cross contamination between an insert to be replaced and its clean replacement, separate tools may be provided for respectively removing the old insert and inserting the new insert. To ensure that the correct tool is used and to prevent the use of the same tool for both removal of a dirty insert and insertion of a clean insert the tools may be adapted to perform only one such function. This can be achieved by shaping the slotted head of the tool to only engage the ribs of the insert when rotated in one direction.

For example, a first tool 250, as shown in FIG. 14, may has a chamfer 260 formed on one side of each groove 253 such that the first tool 250 is only able to engage an insert to rotate the insert in a clockwise direction, for example to unscrew/release the insert.

A second tool 350, as shown in FIG. 15, may have a chamfer 360 on an opposite side of each groove 353 from that of the first tool, such that the second tool is only able to engage an insert to rotate the insert in an anti-clockwise direction, for example to tighten/secure the insert within the discharge opening of the body of the shower head assembly.

The first and second tools 250,250 may be coloured or marked differently from each other to facilitate identification of the correct tool.

The invention is not limited to the embodiment(s) described herein but can be amended or modified without departing from the scope of the present invention.

1. A shower head assembly comprising:
a body having a flow passage therethrough, said flow passage having an outlet opening at an outer end thereof; and
a plurality of inserts, each insert being adapted to be releasably mounted within the outlet opening of the body and including a flow restriction adapted to create a spray of water from the shower head, each insert being securable within the outlet opening by cooperating formations formed on an outer wall of the insert and an inner wall of said outlet opening enabling periodic removal and replacement of the insert from the outlet opening of the body, said inserts are visually distinguishable from one another.

2. (canceled)

3. The shower head assembly as claimed in claim 1, wherein each of said plurality of inserts is a different colour.

4. The shower head assembly as claimed in claim 1, wherein said cooperating formations enable removal of a respective insert from the outlet opening by rotation of the insert with respect to the body.

5. The shower head assembly as claimed in claim 4, wherein said cooperating formations comprise cooperating threads formed on the outer wall of each insert and the inner wall of the outlet opening of the body.

6. The shower head assembly as claimed in claim 4, wherein said cooperating formations comprise:
a bayonet fitting comprising pins provided one of the outer wall of each insert and the inner wall of the outlet opening of the body; and
cooperating L shaped slots provided on the other of the outer wall of each insert; and
the inner wall of the outlet opening for receiving said pins to retain each insert respectively within the outlet opening.

7. The shower head assembly as claimed in claim 4, further comprising a tool having recesses adapted to engage projections formed on an outer face of each insert, said recesses on the tool can be engaged with said projections on a respective insert to facilitate rotation of the insert with respect to the tool.

8. The shower head assembly as claimed in claim 7, further comprising:
a first tool having recesses adapted to engage said projections on a respective insert to enable rotation of the insert in a first direction to enable removal of the insert from the outlet opening; and
a second tool having recesses adapted to engage said projections on a respective insert to enable rotation of the insert in a second direction, opposite said first direction, to enable the insert to be secured within the outlet opening.

9. The shower head assembly as claimed in claim 1, wherein an outer face of each insert includes a plurality of apertures formed therein defining a spray plate.

10. The shower head assembly as claimed in claim 1, wherein each insert includes a deflector element integrally formed therein, said deflector element comprising:
a head portion arranged to be located centrally within the insert; and
an elongate stem extending inwardly from the head portion into said flow passage of the body when the insert is located within the outlet opening of the body to define a flow restriction within said flow passage, the deflector element being supported within the insert by at least one elongate rib extending between the outer wall of the insert and the deflector element.

11. The shower head assembly as claimed in claim 10, wherein the deflector element of each insert is supported by a plurality of radially extending ribs extending between the outer wall of the insert and the deflector element, said ribs being equi-spaced around the deflector element.

12. The shower head assembly as claimed in claim 11, further comprising a tool having recesses adapted to engage projections formed on an outer face of each insert, said recesses on the tool can be engaged with said projections on a respective insert to facilitate rotation of the insert with respect to the tool, said ribs define said projections engaged by said recesses on said tool.

13. The shower head assembly as claimed in claim 10, wherein an underside of the head portion of the deflector element of each insert defines a dish shaped surface facing the flow passage of the body when the respective insert is located within the outlet opening of the body of the shower head.

14. The shower head assembly as claimed in claim 13, wherein the walls of the flow passage of the body comprise an enlarged region having a conical surface converging axially outwardly and terminating in a substantially cylindrical surface to define a bowl shaped region, said head portion of the deflector element is located immediately upstream of said bowl shaped region when the respective insert is located within the outlet opening of the body.

15. The shower head assembly as claimed in claim 10, wherein at least one of a portion of the stem of the deflector element and a cooperating region of the flow passage is tapered or otherwise shaped such that the flow restriction defined by said tapered region within the flow passage can be adjusted by adjusting the axial position of the respective insert within the outlet opening of the body.
